(19) United States
(12) Patent Application Publication
(10) Pub. No.: US 2003/0061924 A1
(43) Pub. Date: Apr. 3, 2003

(54) Cutting apparatus for cutting thermoformed plastic sheet

(75) Inventors: Mircea T. Sofronie, Easton, PA (US); Albert D. Johns, Saylorsburg, PA (US)

Correspondence Address: Martin G. Meder, Georgia-Pacific Corporation, 1915 Marathon Avenue, P. O. Box 899, Neenah, WI, 54957-0899, US

(73) Assignee: Fort James Corporation, Deerfield, IL

(21) Appl. No.: 10/290,898

(22) Filed: Nov. 7, 2002

Related U.S. Application Data
(63) Continuation of application No. 09/680,322, filed on Oct. 6, 2000, now abandoned.
(60) Provisional application No. 60/158,131, filed on Oct. 8, 1999.

(51) Int. Cl. B26D 7/06

(52) U.S. Cl. 83/23

(57) ABSTRACT

A cutting apparatus usable in conjunction with a thermoforming machine that produces a thermoformed plastic sheet is designed to cut the thermoformed plastic sheet to separate a portion of the plastic sheet from the remainder of the plastic sheet. The cutting apparatus includes a cutting mechanism that moves across the width of the sheet. The cutting mechanism is in the form of a cylinder actuated sheet cutting knife whose operation is controlled in conjunction with the operation of the thermoforming machine to effect cutting of the plastic sheet at desired intervals. The apparatus also includes a hold down mechanism that is operated in synchronism with the operation of the thermoforming machine and the cylinder actuated cutting knife. The hold down mechanism is designed to hold down the thermoformed plastic sheet to thereby facilitate the cutting of the plastic sheet. The hold down mechanism is also designed to cover the cutting knife as the cutting knife travels across the width of the thermoformed plastic sheet, thereby preventing the cutting knife from being exposed in a manner that would present a safety risk.

This application is based on and claims priority under 35 U.S.C. §119(e) with respect to U.S. Provisional Application No. 60/158,131, the entire content of which is incorporated herein by reference.

### FIELD OF THE INVENTION

The present invention generally relates to the handling of thermoformed articles. More particularly, the present invention pertains to a cutting apparatus for cutting a sheet of thermoformed plastic articles to separate one portion of the sheet of thermoformed plastic articles from a remaining portion of the sheet of thermoformed plastic articles.

### BACKGROUND OF THE INVENTION

One manner of fabricating plastic items, including plastic containers such as plastic cups, involves thermoforming. This thermoforming operation typically involves continuously conveying a plastic sheet from a roll or directly from an extruder to a heater and then to a thermoforming machine. The thermoforming machine includes many individual die cavities that each correspond in shape to the shape of the plastic article to be produced. In the case of plastic containers such as cups, for example, the individual die cavities possess a shape corresponding to the shape of the finished cup.

The heated plastic sheet is advanced into the thermoforming machine, whereupon portions of the plastic sheet are drawn into the individual die cavities by way of vacuum and pressure. This thus results in a thermoformed plastic sheet in which are formed the articles. After the plastic sheet has been drawn into the individual die cavities to produce a sheet of the thermoformed plastic articles, the vacuum is turned off, relative movement between the plastic sheet and the die cavities is effected to separate the thermoformed articles from the die cavities, and the plastic sheet is then advanced to locate the next part of the continuous plastic sheet in position for thermoforming the next shot of thermoformed articles. The plastic sheet continues to be advanced in this manner, with a plurality of drawn or thermoformed plastic items being formed with each successive shot. The number of thermoformed plastic articles produced in each shot depends upon the size of the articles, the size of the thermoforming machine and other factors, but is not uncommon to produce in excess of 100 articles in each shot.

As the plastic sheet is advanced out of the thermoforming apparatus, the individually formed plastic items remain connected to the plastic sheet. To separate the plastic items from the remainder of the sheet to thereby form individual plastic items, the plastic sheet is conveyed from the thermoforming apparatus to a blanking apparatus. In the blanking apparatus, the individual plastic items are separated from the sheet. As a result, a plurality of individual thermoformed plastic items are produced.

It has been found in this thermoforming operation that it is typically necessary to discard a number of the shots produced by the thermoforming apparatus. During start-up of the thermoforming machine it is oftentimes necessary to adjust various settings and the like associated with the thermoforming machine before acceptable products are produced. At least part of the reason is because parameters such as humidity and temperature affect the characteristics and quality of the products produced by the thermoforming machine. Thus, until the machine settings have been properly set to take into account the existing parameters, the thermoformed products produced by the thermoforming machine are typically unacceptable and must thus be discarded. It is not uncommon in this regard to discard or scrap the first 40-50 shots of thermoformed products, with each shot containing in excess of 100 articles. Once the thermoforming machine has been running for a period of time and has been properly adjusted, the thermoformed products are acceptable, at which time it is no longer necessary to discard or scrap the thermoformed plastic articles produced by the thermoforming machine.

To discard or scrap the unacceptable products, the plastic sheet must be cut at regular intervals as the thermoformed sheet is advanced out of the thermoforming machine. The machine operators typically perform this task using a utility knife to manually cut across the width of the thermoformed plastic sheet. The operators cut the thermoformed plastic sheet while the sheet is at rest and as the next shot of plastic articles is being thermoformed.

While the width of the thermoformed plastic sheet may vary depending upon the type and size of thermoformed article being produced, the width of the thermoformed plastic sheet can be in excess of four feet. This means that two operators are typically required to cut the plastic sheet because it is usually very difficult for a single person to cut the sheet across its entire width. Thus, each of the operators cuts from the middle of the sheet towards the edge of the sheet. This approach raises a variety of difficulties and problems.

To effectively cut the sheet, the two operators must make sure that they each start at the same exact place in the middle of the plastic sheet. This can be a rather difficult task given the quick cycle time of the thermoforming machine. This also means that the operators tend to cut the sheet with a fast stroke. This leads to safety concerns in that the operators cut one another or possible themselves as they try to properly locate their knives and quickly cut the plastic sheet. Indeed, a relatively high incidence of injury has been observed in connection with this practice.

In light of the foregoing, a need exists for a way of reducing or eliminating the safety hazard associated with cutting the thermoformed plastic sheet and allow a portion of the sheet to be separated from a remaining portion of the sheet, for example to remove scrap or unwanted plastic parts from the remainder of the sheet.

### SUMMARY OF THE INVENTION

The present invention provides an apparatus usable in conjunction with a thermoforming machine for cutting a thermoformed plastic sheet of thermoformed articles to remove a portion of the sheet containing thermoformed articles from the remainder of the plastic sheet. The cutting apparatus includes a cutting mechanism that moves across the width of the sheet. In a preferred form of the invention, the cutting mechanism is in the form of a cylinder actuated sheet cutting knife whose operation is controlled in conjunction with the operation of the thermoforming machine so that, for example, with each advancement of the thermoformed plastic sheet, the cylinder actuated sheet cutting knife passes across the width of the sheet. In addition, the apparatus advantageously includes a hold down mechanism that is operated in synchronism with the operation of the thermoforming machine and the cylinder actuated cutting knife. The hold down mechanism is designed to hold down the thermoformed plastic sheet to thereby facilitate the cutting of the plastic sheet. The hold down mechanism also functions to cover the cutting knife as the cutting knife travels across the width of the thermoformed plastic sheet, thereby preventing the cutting knife from being exposed in a manner that would present a safety risk.

In accordance with one aspect of the invention, an assembly for producing thermoformed plastic articles from a plastic sheet includes a thermoforming apparatus for thermoforming plastic articles on the plastic sheet to produce a sheet of plastic thermoformed articles, and a cutting apparatus positioned downstream of the thermoforming apparatus. The cutting apparatus includes a support surface for receiving the sheet of plastic thermoformed articles, and a cutter that is movable across the support surface for cutting the sheet of plastic thermoformed articles located on the support surface to separate a portion of the sheet of plastic thermoformed articles from a remaining portion of the sheet of plastic thermoformed articles.

According to another aspect of the invention, a method of cutting a sheet of plastic thermoformed articles that includes a plurality of plastic thermoformed articles involves conveying the sheet of plastic thermoformed articles onto a support surface of a cutting station, and moving a knife across the width-wise extent of the sheet of plastic thermoformed articles to separate one portion of the sheet of plastic thermoformed articles from a remaining portion of the sheet of plastic thermoformed articles.

Another aspect of the present invention involves an apparatus for cutting a sheet of plastic thermoformed articles having a plurality of thermoformed plastic articles to separate a portion of the sheet of plastic thermoformed articles from a remaining portion of the sheet of plastic thermoformed articles. The apparatus includes a support surface for receiving and supporting the sheet of plastic thermoformed articles, a knife movable across the support surface for cutting through the sheet of plastic thermoformed articles across a width-wise extent of the sheet of plastic thermoformed articles, and a drive device operatively connected to the knife to move the knife across the support surface.

### BRIEF DESCRIPTION OF THE DRAWING FIGURES

The foregoing and additional features and characteristics of the present invention will become more apparent from the detailed description set forth below considered in conjunction with the accompanying drawing figures in which like elements are designated by like reference numerals and wherein:

FIG. 1 is a schematic illustration of the overall setup for producing thermoformed plastic articles, including plastic containers such as plastic cups;

FIG. 2 is a front view of the thermoformed plastic sheet cutting apparatus in accordance with the present invention;

FIG. 3 is a left side view of the cutting apparatus shown in FIG. 2;

FIG. 4 is a cross-sectional view of a portion of the cutting apparatus taken along the sectional line IV-IV in FIG. 2;

FIG. 5 is a cross-sectional view of a portion of the cylinder actuated sheet cutting knife used in the apparatus of the present invention;

FIG. 6 is a front view of the hold down bar forming a part of the cutting apparatus of the present invention;

FIG. 7 is a cross-sectional view of the hold down bar taken along the section line VII-VII in FIG. 6; and

FIG. 8 is a cross-sectional view of a portion of te cutting apparatus showing one of the stationary knife shields that covers the knife as it reaches the end of its length of travel.

### DETAILED DESCRIPTION OF THE INVENTION

Generally speaking, the present invention provides a cutting mechanism used in connection with a thermoforming machine that produces thermoformed plastic parts or articles in a continuous sheet form. The cutting apparatus is designed to cut the thermoformed plastic sheet at desired intervals to separate from the remainder of the sheet a portion of the thermoformed plastic sheet containing thermoformed plastic items. These plastic items may be items that are to be scrapped or discarded. The cutting apparatus includes a knife that is movable across the width of the thermoformed plastic sheet, with the operation of the knife being synchronized with the operation of the thermoforming machine. In a preferred form of the invention, the cutting knife is cylinder actuated. The operation of the knife is preferably controlled in conjunction with the operation of a hold down bar that serves a dual function. The hold down bar engages the thermoformed plastic sheet so that the thermoformed plastic sheet is held down during the cutting operation. This facilitates the cutting operation by ensuring that the thermoformed plastic sheet is tightly held against the underlying surface as the cutting knife moves across the thermoformed plastic sheet. The hold down bar also serves as a safety mechanism that covers the cutting knife as the cutting knife moves across and cuts the thermoformed plastic sheet. Safety hazards possibly resulting in operator injury are thus substantially reduced or eliminated.

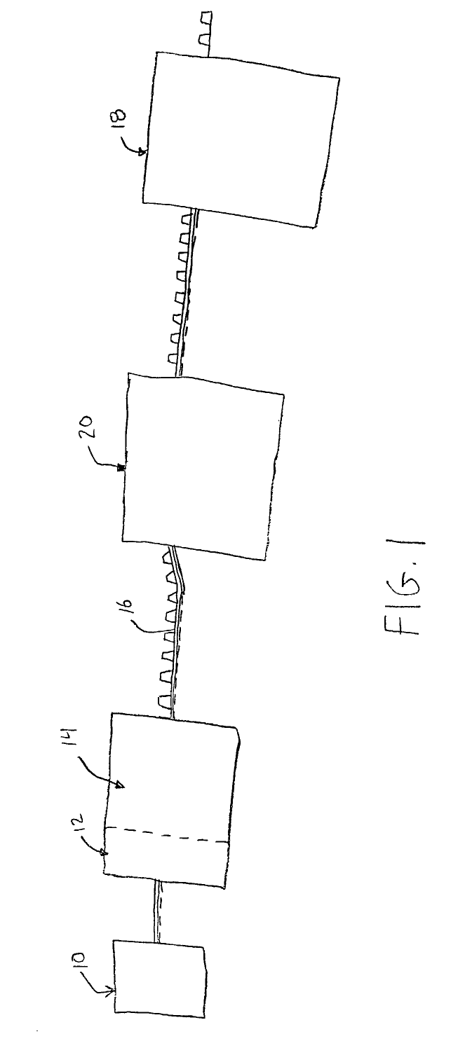

Considering the present invention in more detail, reference is initially made to FIG. 1 which schematically illustrates the context in which the cutting apparatus of the present invention is used. As mentioned above, the cutting apparatus of the present invention has particular application for use in conjunction with thermoforming processes and machines that produce, in a sheet form, thermoformed plastic articles or items, including plastic containers such as plastic cups.

Referring to FIG. 1, the thermoforming operation begins with a plastic sheet. In the illustrated embodiment, the plastic sheet is produced in an extruder 10 and is then directly conveyed from the extruder 10 to a heater 12 that is connected to a thermoforming machine 14. As an alternative to the extruder 10, the plastic sheet that is conveyed to the heater 12 in the thermoforming machine 14 can be unwound from a reel.

The plastic sheet is heated in the heater 12 and is then subjected to a thermoforming operation in the thermoforming machine 14. The specific details associated with the thermoforming operation are known and will thus not be described in detail. However, generally speaking, the thermoforming operation involves the use of thermoforming die cavities that are configured to correspond to the shape of the finished thermoformed article being produced. Thus for instance, in the manufacture of thermoformed plastic containers such as cups, the die cavities possess a shape corresponding to the shape of the container. Through the application of heat and pressure, portions of the heated plastic sheet are displaced into the die cavities. In the system shown in FIG. 1, the thermoforming machine 14 is designed to displace portions of the heated plastic sheet upwardly so that the resulting thermoformed articles on the thermoformed plastic sheet are positioned in a bottom-end-up orientation as shown in FIG. 1.

The plastic sheet is advanced into the thermoforming machine and is then stopped while the vacuum drawing of the articles is carried out. Once the thermoforming operation is complete, the thermoformed plastic sheet is separated from the die-like elements, and the entire thermoformed plastic sheet is then advanced once again to move the just formed shot of thermoformed plastic articles while also locating the next portion of the plastic sheet in position to be subjected to the vacuum drawing operation. The advancement of the plastic sheet is then once again stopped and the next vacuum drawing operation is performed. Typically, many thermoformed plastic articles are produced during each vacuum drawing operation or shot. Although the number can vary depending upon the machine and the size of the articles being produced, in the case of plastic cups, it is not uncommon to produce more than 100 cups in each shot.

As mentioned above, it is oftentimes necessary during operation of the thermoforming machine 14 to scrap or discard some of the thermoformed plastic articles produced in the thermoforming machine. For example, during start-up of the thermoforming machine 14, or perhaps if production on the machine has been temporarily stopped, it is typically necessary to adjust the settings and other parameters associated with the operation of the thermoforming machine 14 based on existing conditions such as, for example, the humidity and temperature. While this calibration or setting of the machine conditions is being performed, the thermoformed products produced in the machine are typically of unacceptable quality. It is thus necessary to cut the thermoformed plastic sheet to remove the portion of the sheet containing the unwanted thermoformed articles from the remainder of the sheet. Depending upon the existing conditions, as many as 40 to 50 shots may have to be scrapped or discarded. The cut portion of the thermoformed plastic sheet containing the discarded or scrap articles is then oftentimes ground up so that it can be recycled. To be able to handle the cut portion of the thermoformed plastic sheet so that it can be ground, the thermoformed plastic sheet is typically cut between each successive shot or between every other shot.

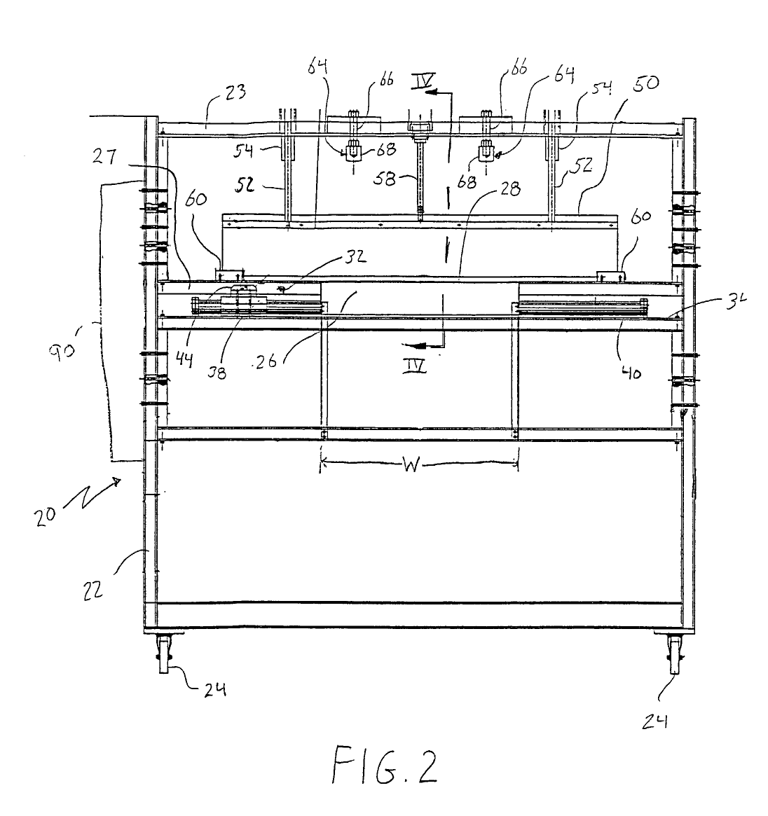

As shown in FIG. 1, the present invention provides a cutting apparatus 20 for performing this cutting operation. The details associated with the cutting apparatus 20 are illustrated in more detail in FIGS. 2-8.

As seen in FIGS. 2 and 3, the cutting apparatus 20 forming a cutting station includes a frame 22 that is mounted on wheels 24 for facilitating transportation of the cutting apparatus 20.

As best seen in FIG. 3, the front side of the cutting apparatus 20 that faces the thermoforming machine is provided with a front table 26. This front table is inclined upwardly and is designed to receive the thermoformed plastic sheet 16 being conveyed out of the thermoforming machine 14. The front table 26 is inclined upwardly to help ensure that the plastic thermoformed sheet 16 being fed into the cutting apparatus 20 is generally lying in a flat state.

The frame 22 is also provided with a sheet support table 27 having an upper surface defining a sheet support surface 28 that receives the thermoformed plastic sheet from the inclined front table 26. A rear table 30 receives the thermoplastic sheet from the sheet support surface 28. Thus, the thermoformed plastic sheet from the thermoforming machine is advanced up the inclined front table 26, across the sheet support surface 28 and to the rear table 30.

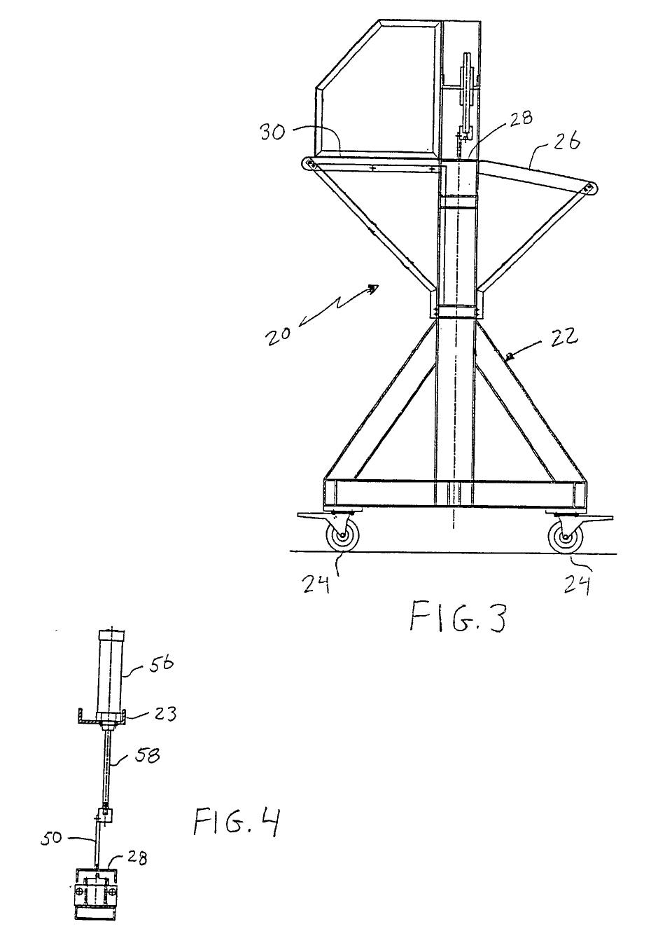

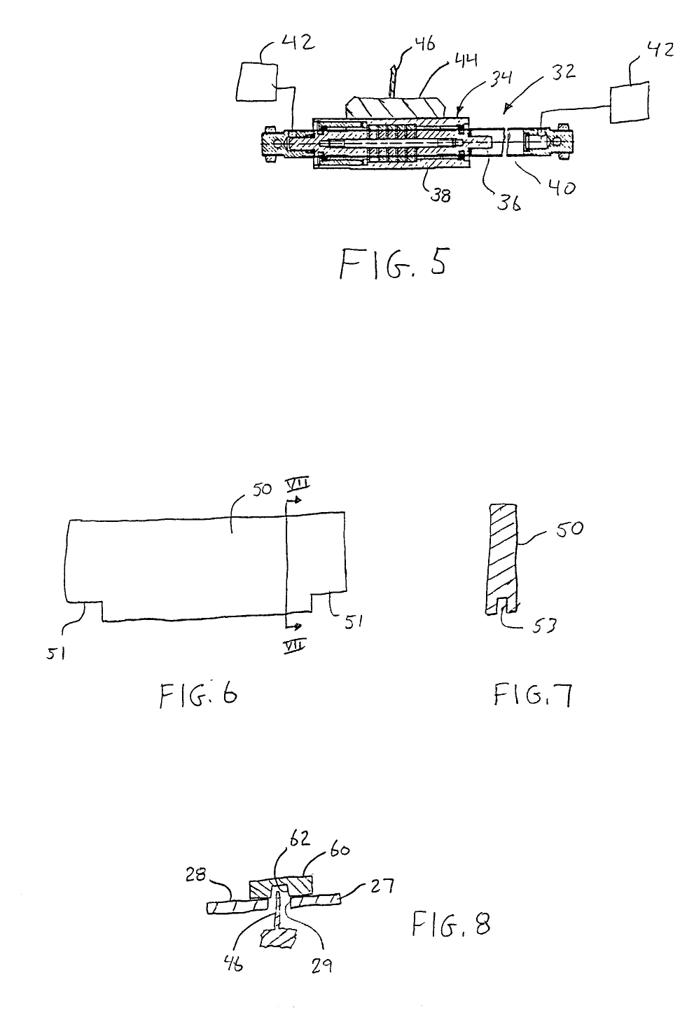

The cutting apparatus 20 is also provided with a cutting mechanism 32. In one form of the present invention, the cutting mechanism 32 is in the form of a cylinder actuated cutting mechanism. The cutting mechanism 32 is mounted on a cross support 34 that is secured within the frame 22. The general details associated with the cutting mechanism 32 are illustrated in FIG. 5.

As seen in FIG. 5, the cutting mechanism 32 is in the form of a double-acting rodless cylinder 34. Double-acting rodless cylinders of this type are known in the industry and are commercially available. Thus, a detailed description of all of the details associated with the double-acting rodless cylinder will not be set forth here, except to facilitate an understanding of the present invention.

Generally speaking, the rodless cylinder 34 is comprised of an internal piston 36 and an external yoke 38. The internal piston 36 is positioned within a cylinder 40 and the external yoke 38 slides along the external surface of the cylinder 40. Both the internal piston 36 and the external yoke 38 are provided with magnets to magnetically couple the internal piston 36 and the external yoke 38 together as illustrated in FIG. 5 so that axial movement of the internal piston 36 within the cylinder interior results in axial movement of the external yoke 38 along the exterior of the cylinder 40.

To effect axial movement of the internal piston 36 within the cylinder interior, each end of the cylinder interior is connected to a source of air or hydraulic pressure 42. By appropriately controlling the air or hydraulic pressure source 42, the internal piston 36 can be driven back and forth along the axial extent of the cylinder interior. The magnetic force of the internal piston 36 pulls the external yoke 38 along the cylinder 40. As the internal piston 36 moves axially, the working force is transferred to the external yoke 38. The axial end positions of the internal piston 36 can be detected by proximity sensors using the magnetic field of the external yoke 38. Thus, upon detecting that the internal piston 36 has reached one of the axial ends of the cylinder interior, the air or hydraulic pressure source 42 can be controlled to prevent further application of air or hydraulic pressure to the cylinder interior.

As further illustrated in FIG. 5, a knife holder 44 is secured to the external yoke 38 so that the knife holder 44 moves with the external yoke 38. An upstanding cutting knife or other suitable cutter 46 is secured in the knife holder 44 so that the external yoke 38, the knife holder 44 and the knife 46 move together as a unit as the internal piston 36 is driven back and forth by virtue of the air or hydraulic pressure delivered to the cylinder interior. The knife 46 moves in a plane that is generally perpendicular to the sheet support surface 28. The cutting knife 46 extends through a slot 29 that is formed in the sheet support table 27 as shown in FIG. 8. The cutting knife 46 also extends above the plane defined by the upwardly facing sheet support surface 28.

Referring back to FIGS. 2 and 3, the cutting apparatus also includes a hold down bar 50. The hold down bar 50 is connected to a pair of guide rods 52 that are slidably guided within guide sleeves 54 mounted on an upper support 23 of the frame 22. The hold down bar 50 is also connected to the piston 58 of an air cylinder 56. As shown in FIG. 4, the air cylinder 56 is mounted on the upper support 23 of the frame 22.

Through operation of the air cylinder 56, the hold down bar 50 is moved vertically in an up and down manner. The vertical movement of the hold down bar 50 is guided by the guide rods 52 sliding within the respective guide sleeves 54. The hold down bar 50 moves vertically in a plane that is parallel to and aligned with the plane of axial movement of the cutting knife 46.

As seen in FIGS. 6 and 7, notched regions 51 are provided at the lower portion of the hold down bar 50 at the opposite ends of the hold down bar 50 for accommodating safety blocks mounted on the sheet support surface 28 in a manner described below in more detail. In addition, the bottom edge of the hold down bar 50 is provided with a slot 53 that is adapted to receive the upstanding cutting knife 46 when the hold down bar 50 is located in its lowermost position illustrated in FIG. 2.

The hold down bar 50 serves a dual purpose. First, the hold down bar 50 is designed to press against the thermoformed plastic sheet and thus hold down the thermoformed plastic sheet against the sheet support surface 28. This is advantageous from the standpoint of facilitating the cutting operation in that the knife 46 is able to more easily cut the thermoformed plastic sheet than would otherwise be the case if the thermoformed plastic sheet was not firmly held against the sheet support surface 28. In addition, the hold down bar 50 covers the cutting knife 46 as the knife 46 moves across the width of the thermoformed plastic sheet. The hold down bar 50 thus provides a safety mechanism preventing injury to the operator.

As seen in FIG. 2, a pair of safety blocks 60 is mounted on the sheet support surface 28. These safety blocks 60 are positioned at locations defining the two opposite extremes of the axial movement of the cutting knife 46. As shown in more detail in FIG. 8, each of the safety blocks 60 is mounted on the sheet support table 27 so that the safety block 60 straddles the slot 29 that is formed in the sheet support table 27. The bottom surface of each of the safety blocks 60 is provided with a slot 62 that is aligned with the slot 29 formed in the sheet support table 27.

The purpose for the safety block 60 is to cover the cutting knife 46 when the cutting knife 46 reaches the two extreme end positions of its path of travel. As described below in more detail, this is important because after the cutting knife has moved across and cut the thermoformed plastic sheet, the hold down bar 50 is raised. Thus, while the hold down bar 50 is able to cover the knife 46 when the hold down bar 50 is in its downward most position, the hold down bar 50 is no longer able to cover the knife 46 after the hold down bar 50 is raised. The hold down bar 50 is only raised once the knife 46 has reached its axial endmost position and so the stationary safety blocks 60 are disposed at locations corresponding to these axial endmost positions of the cutting knife 46, thus providing a mechanism for covering the knife 46 when the hold down bar is raised 50. In this way, the cutting knife is not exposed between cutting operations, thus eliminating a potential safety hazard.

A pair of stop mechanisms 64 are also secured to the upper support 23 of the frame 22. Each of the stop mechanisms 64 includes a threaded rod 66 provided at its end with a bumper 68. The threaded rods 66 threadably engage the upper support 23 and can thus be adjusted vertically to adjust the position of the bumper 68.

The purpose for the stop mechanisms 64 is to adjust the degree to which the hold down bar 50 is raised. As described above, the cutting apparatus of the present invention can be used in connection with the production of thermoformed plastic articles that exit the thermoforming machine in a bottom-end-up position as shown in FIG. 1. Thus, to allow the thermoformed plastic sheet to move past the hold down bar 50 after production of each successive shot of thermoformed plastic articles, the hold down bar 50 must be raised. The extent to which the hold down bar 50 must be raised to allow passage of the thermal formed plastic sheet depends upon the size of the thermoformed plastic articles. Thus, the hold down bar need not be raised as high when producing relatively smaller size articles as compared to relatively larger size articles. While it is possible to raise the hold down bar 50 to its uppermost position after each cutting operation, it is preferable to raise the hold down bar 50 only to the extent necessary to permit passage of the thermoformed plastic sheet and thermoformed plastic articles so that the time associated with the up and down stroke of the hold down bar 50 is as short as possible. The stopper mechanism 64 provides a mechanism for limiting or controlling the extent to which the hold down bar 50 is raised, and allows the extent to which the hold down bar 50 is raised to be adjusted in accordance with the size of the thermoformed plastic articles.

Having described the features associated with the cutting apparatus of the present invention, the operation of the apparatus will now be described. As mentioned above, the cutting apparatus 20 of the present invention is intended to be used whenever it is necessary to cut a thermoformed plastic sheet, for example to remove thermoformed articles of unacceptable quality that are produced upon machine start-up. The cutting apparatus 20 is positioned downstream of the thermoforming machine in the manner shown in FIG. 1 so that the thermoformed plastic sheet exiting the thermoforming machine 14 is conveyed up the front table 26. The dimension W in FIG. 2 represents the width of the thermoformed plastic sheet and its location as it is conveyed into the cutting apparatus. Each operating cycle of the thermoforming machine produces a shot of thermoformed articles. After a shot of thermoformed articles has been produced, the thermoformed plastic sheet is advanced or indexed to form the next shot of thermoformed plastic articles. The advancement of the plastic sheet is then temporarily stopped while the thermoforming operation is carried out. This process continues in a continuous manner with each subsequently produced shot of thermoformed articles causing the plastic sheet to be advanced.

The advancement of the plastic sheet moves the thermoformed plastic sheet across the sheet support surface 28 of the sheet support table 27. While the thermoformed plastic sheet is at rest (i.e., while a subsequent shot of plastic article is being thermoformed), the hold down bar 50 is moved vertically downward from its uppermost position as defined by the location of the stopper mechanism 64. The hold down bar 50 moves vertically downward from its uppermost position to its downward most position which is illustrated in FIG. 2. When the hold down bar 50 reaches its downward most position, the hold down bar 50 engages the thermoformed plastic sheet and holds the thermoformed plastic sheet against the sheet support surface 28.

With the hold down bar 50 in its downward most position, the cutting mechanism 32 is actuated. Assuming the cutting knife 46 is located at the left side position shown in FIG. 2, the air or hydraulic pressure source 42 shown in FIG. 5 introduces air or hydraulic pressure into the left end of the cylinder interior to cause the internal piston 36 to move to the opposite end of the cylinder 40 (i.e., to the right side position). The movement of the internal piston 36 towards the opposite end of the cylinder interior causes the external yolk 38 as well as the knife holder 44 and the knife 46 to move in the same manner. The cutting knife 46 thus cuts the thermoformed plastic sheet across the width-wise extent of the thermoformed plastic sheet. As the knife 46 moves across the thermoformed plastic sheet, the cutting knife 46 is covered by the slot 53 in the hold down bar 50. This thus eliminates any safety hazard associated with the operation of the cutting mechanism 32.

When the cutting knife reaches the opposite end of the cylinder 40, the cutting knife 46 is no longer covered by the slot 53 in the hold down bar 50, but rather is positioned within the slot 62 that is formed in the safety block 60. The knife 46 thus remains covered and is not exposed in a manner that would present a safety hazard to the operator. When the cutting knife reaches the opposite end of the cylinder 40, the air cylinder 56 is operated to raise the hold down bar 50. Thus, when the shot of articles undergoing thermoforming is completed and the thermoforming sheet is advanced, the advancing thermoformed plastic sheet will be able to advance under the hold down bar 50. This advancement of the plastic sheet also advances the just cut portion of the thermoformed plastic sheet so that it is eventually pushed off the rear table 30 and onto the floor. The cut portion of the thermoformed plastic sheet can then be put through a grinder and recycled or otherwise discarded.

The advancement of the thermoformed plastic sheet resulting from continued operation of the thermoforming machine is once against stopped so that the next shot of thermoformed plastic articles can be produced. The hold down bar 50 is once again moved downward to its downward most position shown in FIG. 2 to once again press the thermoformed plastic sheet against the sheet support surface 28. The cutting mechanism 32 is then actuated to move the knife 46 back towards the opposite end of the cylinder (i.e., to the left side position) in a manner similar to that described above. That is, the air or hydraulic pressure source 42 introduces air or hydraulic pressure into the right end of the cylinder interior to cause the internal piston 36 to move towards the opposite end of the cylinder 40. The external yolk 38, the knife holder 44 and the knife 46 move with the internal piston 36 by way of the magnetic coupling. During this movement, the cutting knife 46 once again cuts the thermoformed plastic sheet across its widthwise extent and eventually reaches the leftmost position. At this position, the cutting knife 46 is covered by the adjoining safety block 60. The hold down bar 50 is then once again raised to allow the thermoformed plastic articles to pass under the hold down bar 50 during the next advancement of the thermoformed plastic sheet.

The foregoing process continues until the thermoformed plastic articles produced by the thermoforming machine meet acceptable standards of quality at which time it is no longer necessary to cut the thermoformed plastic sheet. At this time, the operation of the cutting apparatus 20 is stopped and the thermoformed plastic sheet is conveyed to the trimming or blanking apparatus 18 shown in FIG. 1 forming a trimming or blanking station. Here, the individual thermoformed articles are cut out from the remainder of the thermoformed plastic sheet to produce individual thermoformed articles.

As can be seen from the foregoing, the operation of the cutting apparatus is synchronized with the operation of the thermoforming machine so that between successive shots of thermoformed articles, the thermoformed plastic sheet is cut. It is of course to be understood that the thermoformed plastic sheet need not be cut between each successive shot of thermoformed plastic articles. For example, the operation of the cutting apparatus can be synchronized with the operation of the thermoforming machine so that the cutting apparatus cuts the thermoformed plastic sheet after every other shot of thermoformed plastic articles or after every third shot of thermoformed articles.

The cutting apparatus can also be provided with a control panel 90 as shown in FIG. 2 that allows the operator to appropriately control the operation of the cutting apparatus. It has been found to be particularly useful to design the control mechanism for the cutting apparatus so that the cutting apparatus is operational in three different modes. In one mode, the operator is able to manually control the operation of the cutting apparatus by pushing a button that causes the hold down bar 50 to move downwardly and the cutting mechanism 32 to move across and cut the thermoformed plastic sheet. This manual mode allows the operator to control when the cutting mechanism is actuated. In other words, the operator has complete freedom with respect to actuating the cutting mechanism relative to the operating cycle of the thermoforming machine.

According to a second mode of operation, the cutting apparatus can be set to automatically cut the thermoformed plastic sheet after each successive shot of thermoformed plastic articles is produced. In this automatic mode, the operation of the cutting apparatus is synchronized with the operation of the thermoforming machine, and so the operator need not manually actuate the operation of the cutting mechanism.

In a third operating mode, the apparatus can be designed to actuate the cutting mechanism between every second shot of thermoformed plastic articles, every third shot of thermoformed articles, or at any other interval. The actuation of the cutting mechanism would once again be automatically actuated. This latter mode offers the advantage of controlling the length of the discarded thermal plastic sheet. This may be advantageous in certain circumstances such as when producing relatively small thermoformed plastic articles where the length of thermal plastic sheet between successive shots is rather small. In these situations, actuating the cutting mechanism between every second shot, every third shot or at some other interval would allow longer lengths of cut thermoformed plastic sheets to be produced which may be easier to handle if the cut thermoformed plastic sheet is to be grinded and recycled.

By virtue of the present invention, it is advantageously possible to reduce or eliminate the safety hazards associated with other known methods of cutting thermoformed plastic sheets for purposes of removing scrap or otherwise undesirable plastic articles. The cutting apparatus according to the present invention can be synchronized with the operation of the thermoforming machine so that significant operator involvement is not required. Also, the present invention does not require modification of existing systems for producing thermoformed plastic articles, but rather can be included in an in-line manner with existing production lines.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims be embraced thereby.

What is claimed is:

1. An assembly for producing thermoformed plastic articles from a plastic sheet comprising:
a thermoforming apparatus for thermoforming plastic articles on the plastic sheet to produce a sheet of plastic thermoformed articles; and
a cutting apparatus positioned downstream of the thermoforming apparatus, the cutting apparatus including a support surface for receiving the sheet of plastic thermoformed articles and a cutter that is movable across the support surface for cutting the sheet of plastic thermoformed articles located on the support surface to separate a portion of the sheet of plastic thermoformed articles from a remaining portion of the sheet of plastic thermoformed articles.

2. The assembly according to claim 1, including a movable hold down bar movable towards and away from the support surface between a first position in which the hold down bar is spaced from the sheet of plastic thermoformed articles and a second position in which the hold down bar presses against an upper surface of the sheet of plastic thermoformed articles to hold down the sheet of plastic thermoformed articles on the support surface.

3. The assembly according to claim 1, wherein the cutter is a knife that is movable across a width-wise extent of the support surface.

4. The assembly according to claim 1, wherein the cutter is a knife, and including a knife holder attached to a double acting rodless cylinder, the knife being attached to the knife holder and the double acting rodless cylinder being adapted to move the knife across the width-wise extent of the support surface.

5. The assembly according to claim 2, wherein the hold down bar has a bottom surface facing towards the support surface, the bottom surface including a slot adapted to receive and cover the cutter when the hold down bar is in the first position.

6. The assembly according to claim 1, including at least one vertically adjustable stop mechanism for limiting movement of the hold down bar away from the support surface.

7. The assembly according to claim 2, wherein the cutter is movable between two opposite extreme end positions, and including a pair of safety blocks each mounted on the support surface at a position corresponding in location to one of the extreme end positions, the cutter extending above the support surface as the cutter moves between the extreme end positions, the cutter being covered by one of the safety blocks when the cutter is at one of the extreme end positions.

8. The assembly according to claim 1, further comprising a blanking apparatus positioned downstream of the cutting apparatus for separating individual ones of the plastic thermoformed articles from the sheet of plastic thermoformed articles.

9. A method of cutting a sheet of thermoformed plastic comprising:
conveying the sheet of thermoformed plastic onto a support surface of a cutting station; and
moving a knife across a width-wise extent of the sheet of thermoformed plastic to separate one portion of the sheet of thermoformed plastic from a remaining portion of the sheet of thermoformed plastic.

10. The method according to claim 9, wherein the sheet of thermoformed plastic is a sheet of thermoformed plastic articles having a plurality of thermoformed articles, the knife extending above the support surface during movement of the knife across the width-wise extent of the sheet of plastic thermoformed articles, and including covering the knife during movement across the width-wise extent of the sheet of plastic thermoformed articles.

11. The method according to claim 10, including lowering a hold down bar into contacting engagement with an upper surface of the sheet of plastic thermoformed articles prior to movement of the knife across the width-wise extent of the sheet of plastic thermoformed articles to hold down the sheet of plastic thermoformed articles.

12. The method according to claim 11, wherein the knife is covered by a slot formed on a bottom surface of the hold down bar.

13. The method according to claim 11, including raising the hold down bar after the knife has cut the sheet of plastic thermoformed articles to separate the one portion of the sheet of plastic thermoformed articles from the remaining portion of the sheet of plastic thermoformed articles.

14. The method according to claim 9, wherein the sheet of thermoformed plastic is a sheet of thermoformed plastic articles having a plurality of thermoformed articles, and including successively advancing and stopping the sheet of plastic thermoformed articles, the knife being moved across the width-wise extent of the sheet of plastic thermoformed articles to separate the one portion of the sheet of plastic thermoformed articles from the remaining portion of the sheet of plastic thermoformed articles based on a determination that a quality of at least some of the thermoformed plastic articles in the one portion of the sheet of plastic thermoformed articles is unacceptable, and the knife being maintained in a stationary position based on a determination that the quality of the plastic thermoformed articles located adjacent the cutting station is acceptable.

15. The method according to claim 9, wherein the sheet of thermoformed plastic is a sheet of thermoformed plastic articles having a plurality of thermoformed articles, and including conveying the sheet of plastic thermoformed articles to the support surface from a thermoforming machine at which the plastic thermoformed articles are formed.

16. An apparatus for cutting a sheet of thermoformed plastic to separate a portion of the sheet of thermoformed plastic from a remaining portion of the sheet of thermoformed plastic, comprising:
a support surface for receiving and supporting the sheet of thermoformed plastic;
a knife movable across the support surface for cutting through the sheet of thermoformed plastic across a width-wise extent of the sheet of thermoformed plastic; and
a drive device operatively connected to the knife to move the knife across the support surface.

17. The apparatus according to claim 16, wherein the drive device includes a double acting rodless cylinder, and including a knife holder attached to the double acting rodless cylinder, the knife being attached to the knife holder.

18. The apparatus according to claim 16, including a movable hold down bar movable towards and away from the support surface between a first position in which the hold down bar is spaced from the sheet of thermoformed plastic and a second position in which the hold down bar presses against an upper surface of the sheet of thermoformed plastic to hold down the sheet of thermoformed plastic on the support surface.

19. The apparatus according to claim 16, wherein the knife extends above the support surface, the hold down bar having a bottom surface provided with a slot that receives and covers the knife as the knife moves across the support surface.

20. The assembly according to claim 16, wherein the knife moves across the support surface between two opposite extreme end positions, and including a safety block positioned at each of the opposite extreme end positions to cover the knife when the knife is positioned at the opposite extreme end positions.
